(19) United States
(12) Patent Application Publication
(10) Pub. No.: US 2026/0367965 A1
(43) Pub. Date: Nov. 19, 2026

(54) LOW CODE WORKFLOW AUTOMATION TOOL

(71) Applicant: Fidelity Information Services, LLC, Jacksonville, FL (US)

(72) Inventors: Suresh RAJENDRAN, Chennai (IN); Arun Pandian MAHALINGAM, Erode (IN); Prakash Kumar JEYAGOPALAN, Chennai (IN); Joseph Xavier DASAIAN, Chennai (IN)

(73) Assignee: Fidelity Information Services, LLC, Jacksonville, FL (US)

(21) Appl. No.: 19/208,260

(22) Filed: May 14, 2025

(51) Int. Cl. G06F 9/48

(52) U.S. Cl. CPC G06F 9/4881

(57) ABSTRACT

A computer-implemented method for enhancing computer system workflow efficiency may include scheduling first, second, and third tasks, monitoring a first file folder to detect a change to the first file folder, receiving first data and storing the first data in the first file folder, which causes a change to the first file folder, responsive to storing the first data in the first file folder, detecting the change to the first file folder, and responsive to detecting the change to the first file folder, implementing the first, second, and third tasks. The first task may include processing the first data. The second task may include generating a report based on the processed first data and storing the report in a first server. The third task may include transmitting the report to one or more user accounts associated with a second server.

### TECHNICAL FIELD

Various embodiments of the present disclosure relate generally to systems and methods for enhancing computer system workflow efficiency, for example, by reducing the need for manual intervention in task execution and data handling.

### BACKGROUND

Conventional systems for managing financial and transactional activities may require numerous manual interventions, such as archiving backup files, transferring logs, and/or relocating files across different systems. These tasks are often performed manually, resulting in significant time consumption and potential for human error. For example, a transaction record generated in one system may need to be manually exported, verified, and imported into a different system for long-term storage or compliance purposes.

In this process, certain tasks may be unable to begin until a preceding task is completed, and uncertainty regarding its completion time often delays subsequent tasks, for example, when manual intervention is required to initiate the next step and does not occur immediately after the preceding task finishes. In addition, if these tasks are performed during peak daytime hours when system workload is high and network speeds are relatively low, it can further decrease overall system efficiency and lead to additional delays.

The background description provided herein is for the purpose of generally presenting context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

In some aspects, the techniques described herein relate generally to a computer-implemented method for enhancing computer system workflow efficiency. The method may include scheduling first, second, and third tasks, monitoring a first file folder to detect a change to the first file folder, receiving first data and storing the first data in the first file folder, which causes a change to the first file folder, responsive to storing the first data in the first file folder, detecting the change to the first file folder, and responsive to detecting the change to the first file folder, implementing the first, second, and third tasks. The first task may include processing the first data. The second task may include generating a report based on the processed first data and storing the report in a first server. The third task may include transmitting the report to one or more user accounts associated with a second server. Transmitting the report may include transferring the report in the first server to the second server. The one or more user accounts may have access to the second server and may not have access to the first server. The implementation of the first task may trigger the implementation of the second task, and the implementation of the second task may trigger the implementation of the third task.

In some aspects, the techniques described herein relate to a system for enhancing computer system workflow efficiency. The system may include one or more processors of a computing system; and at least one non-transitory computer readable medium storing instructions which, when executed by the one or more processors, cause the one or more processors to perform operations comprising: scheduling first, second, and third tasks, monitoring a first file folder to detect a change to the first file folder, receiving first data and storing the first data in the first file folder, which causes a change to the first file folder, responsive to storing the first data in the first file folder, detecting the change to the first file folder, and responsive to detecting the change to the first file folder, implementing the first, second, and third tasks. The first task may include processing the first data. The second task may include generating a report based on the processed first data and storing the report in a first server. The third task may include transmitting the report to one or more user accounts associated with a second server. Transmitting the report may include transferring the report in the first server to the second server. The one or more user accounts may have access to the second server and may not have access to the first server. The implementation of the first task may trigger the implementation of the second task, and the implementation of the second task may trigger the implementation of the third task.

In some aspects, the techniques described herein relate to a non-transitory computer readable medium storing instructions which, when executed by one or more processors of a computing system, cause the one or more processors to perform operations including: scheduling first, second, and third tasks, monitoring a first file folder to detect a change to the first file folder, receiving first data and storing the first data in the first file folder, which causes a change to the first file folder, responsive to storing the first data in the first file folder, detecting the change to the first file folder, and responsive to detecting the change to the first file folder, implementing the first, second, and third tasks. The first task may include processing the first data. The second task may include generating a report based on the processed first data and storing the report in a first server. The third task may include transmitting the report to one or more user accounts associated with a second server. Transmitting the report may include transferring the report in the first server to the second server. The one or more user accounts may have access to the second server and may not have access to the first server. The implementation of the first task may trigger the implementation of the second task, and the implementation of the second task may trigger the implementation of the third task.

### BRIEF DESCRIPTION OF THE DRAWINGS

The accompanying drawings, which are incorporated in and constitute a part of this specification, illustrate several embodiments and together with the description, serve to explain the principles of the disclosure.

FIG. 1 illustrates a schematic of a system for enhancing computer system workflow efficiency according to an example of the present disclosure.

FIG. 2 is a flowchart showing a process for enhancing computer system workflow efficiency according to an aspect of the present disclosure.

FIG. 3 illustrates a flow diagram for training a machine learning model, in accordance with an aspect of the disclosed subject matter.

FIG. 4 illustrates an implementation of a computer system that executes techniques presented herein according to an example of the present disclosure.

FIG. 5 illustrates a system for enhancing computer system workflow according to an example of the present disclosure.

FIGS. 6-11 illustrate user interfaces of a system according to an example of the present disclosure.

### DETAILED DESCRIPTION OF EMBODIMENTS

Various embodiments of the present disclosure relate generally to systems and methods for enhancing computer system workflow efficiency, for example, by reducing the need for manual intervention in task execution and data handling.

Conventional systems for managing financial and transactional activities may require numerous manual interventions, such as archiving backup files, transferring logs, and/or relocating files across different systems. These tasks are often performed manually, resulting in significant time consumption and potential for human error. For example, a transaction record generated in one system may need to be manually exported, verified, and imported into a different system for long-term storage or compliance purposes.

In this process, certain tasks may be unable to begin until a preceding task is completed, and uncertainty regarding its completion time often delays subsequent tasks, for example, when manual intervention is required to initiate the next step and does not occur immediately after the preceding task finishes. In addition, if these tasks are performed during peak daytime hours when system workload is high and network speeds are relatively low, it can further decrease overall system efficiency and lead to additional delays. For these reasons, running a job or workflow that includes tasks, such as report generation and/or transferring files between servers, may require a significant amount of time (e.g., 5 to 10 hours).

The system according to an example of the present disclosure may address the above-discussed problems in the conventional systems by providing a system and method for enhancing computer system workflow efficiency, for example, by reducing the need for manual intervention in task execution and data handling. For example, aspects of the present disclosure may automate (repetitive) interdependent task execution, reducing reliance on manual operations for data transfer and file management, and minimizing latency caused by uncertain task completion times and variable system load conditions. In this way, the system according to an example of the present disclosure may be able to streamline the process of task execution and free up resources for more high-value activities. Aspects of the present disclosure may enable a job or workflow including tasks, such as report generation and/or file transfers between different servers or systems, to be completed significantly faster than in conventional systems (e.g., in seconds or minutes).

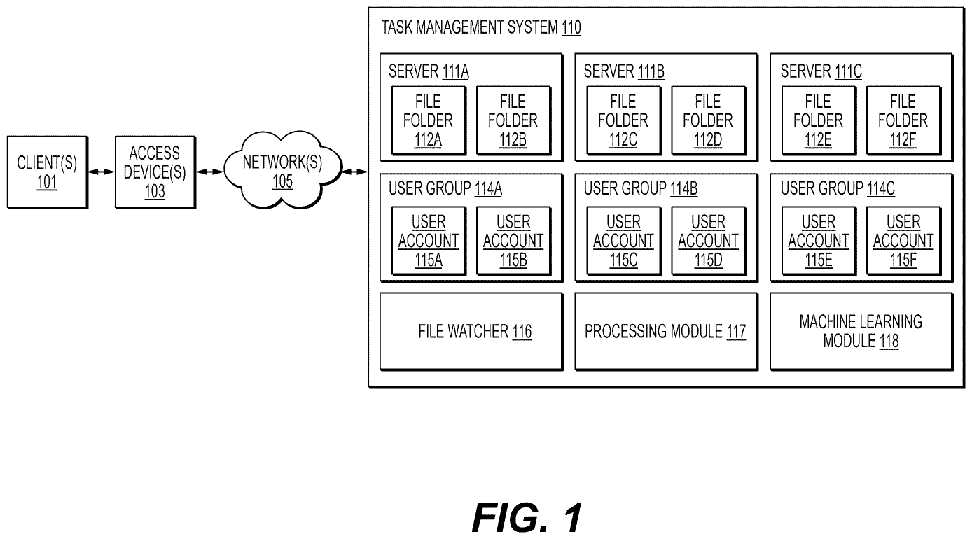

FIG. 1 illustrates a system for enhancing computer system workflow efficiency according to an example of the present disclosure. As shown in FIG. 1, one or more access devices 103 may be associated with the one or more clients 101, and a task management system 110 may be in communication with the one or more access devices 103 through one or more networks 105.

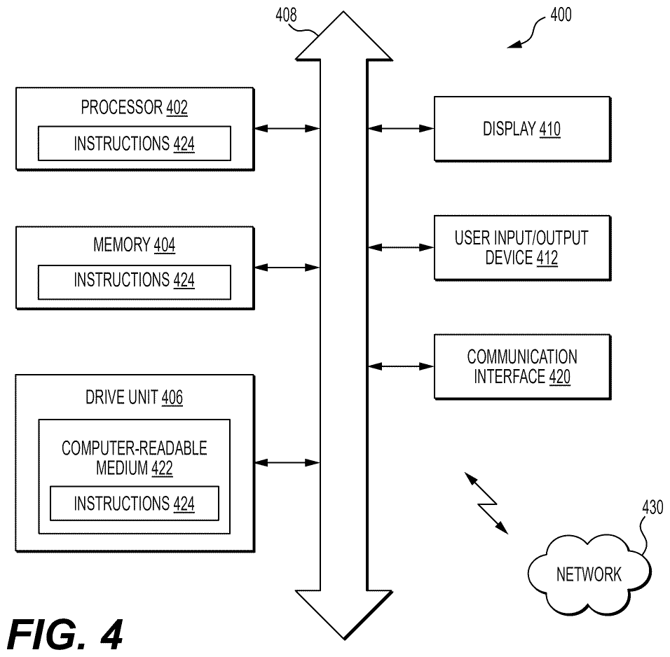

The one or more clients 101 may be individuals, companies, or other entities having an account with a financial or an online transaction processing system (which may include the task management system 110). The one or more access devices 103 may include any type of mobile, wireless, fixed, or portable terminal used by the one or more clients 101 to communicate with other components within the task management system 110. Examples of the one or more access devices 103 may include, but are not limited to, a mobile handset, a wireless communication device, a multimedia computer (e.g., computer system 400, described below with reference to FIG. 4), an Internet-enabled node, a data server, or any instrument or tool that enables the one or more clients 101 to initiate an online transaction. The online transaction may include receiving and/or passing one or more messages from one system/server to another system/server for any transaction messages.

The one or more networks 105 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The one or more networks 105 may include wide area networks (WAN), such as the Internet, local area networks (LAN), campus area networks, metropolitan area networks, a direct connection such as through a Universal Serial Bus (USB) port, or any other networks that may allow for data communication. The one or more networks 105 may be configured to couple one computing device to another computing device to enable communication of data between the devices. The one or more networks 105 may generally be enabled to employ any form of machine-readable media for communicating information from one device to another. The one or more networks 105 may include communication methods by which information may travel between computing devices. The one or more networks 105 may be divided into sub-networks. The sub-networks may allow access to all of the other components connected thereto or the sub-networks may restrict access between the components. The one or more networks 105 may be regarded as a public or private network connection and may include, for example, a virtual private network or an encryption or other security mechanism employed over the public Internet, or the like. In other examples, no network is provided. In this case, the one or more access devices 103 may communicate with one or more components in the task management system 110 directly.

In some examples, the task management system 110 may include a plurality of servers 111A-C, a plurality of (internal) user accounts 115A-F, a file watcher 116, a processing module 117, and a machine learning module 118. In some examples, the task management system 110 may be part of an upper system for managing various data related to financial and transactional activities (e.g., online transactions from the client(s) 101) and handling tasks related to the management of the various data. The task management system 110 may be provided to facilitate the implementation of the tasks in the upper system, for example, by minimizing manual interventions and automating various tasks and workflows.

In some examples, the plurality of servers 111A-C may include one or more file folders 112A-F. The one or more file folders 112A-F may serve as a container for organizing and/or storing one or more files or data within the task management system 110. The one or more file folders 112A-F may restrict or allow access by the one or more user accounts 115A-F to keep the files and data within the one or more file folders 112A-F protected. In some examples, the one or more file folders 112A-F may store metadata (e.g., timestamps or access rights) that may apply to files or data within the one or more file folders 112A-F.

In some examples, the plurality of user accounts 115A-F may be an account for users in the task management system 110 and/or the upper system who manage various data and tasks related to the financial and transactional activities (e.g., online transactions from the client(s) 101) using the task management system 110. In some examples, the plurality of user accounts 115A-F may be in one or more different user groups 114A-C. For example, user accounts 115A-B may be in a first user group 114A, user accounts 115C-D may be in a second user group 114B, and user accounts 115E-F may be in a third user group 114C. The user accounts 115A-B in the first user group 114A may have access to the first server 111A (and one or more file folders 112A-B therein), but may not have access to the second server 111B and/or the third server 111C. The user accounts 115C-D in the second user group 114B may have access to the second server 111B (and one or more file folders 112C-D therein), but may not have access to the first server 111A and/or the third server 111C. The user accounts 115E-F in the third user group 114C may have access to the third server 111C (and one or more file folders 112E-F therein), but may not have access to the first server 111A and/or the second server 111B.

In some examples, the file watcher 116 may be configured to monitor changes in the one or more file folders 112A-F in the servers 111A-C. For example, the file watcher 116 may monitor whether file or data in the one or more file folders 112A-F is created, modified, deleted, or moved. In some examples, the file watcher 116 may monitor the changes to the one or more file folders 1112A-F periodically. Upon detecting a change to the one or more file folders 112A-F, the file watcher 116 may transmit a notification, for example, to the processing module 117 about the change to the one or more file folders 112A-F.

In some examples, the processing module 117 may implement various functions to operate the task management system 110. Examples of the functions of the processing module 117 may include receiving, storing, processing, and transferring files or data, scheduling one or more tasks, or generating, storing, and transferring a report. For example, the processing module 117 may receive data or files and store the data or files in the one or more file folders 112A-F of the servers 111A-C, which may cause a change to the one or more file folders 112A-F.

In some examples, the data or files may be transmitted from an external system (e.g., access device(s) 103) to the task management system 110. The data or files may be related to the request for the online transactions from the access device(s) 103. The files or data may include transaction logs, access logs, customer data files, or backup files.

The processing module 117 may schedule one or more tasks that may be triggered once a change (e.g., file or data stored, modified, deleted, or moved) to the one or more file folders 112A-F are detected by the file watcher 116. For example, once a notification about a change to the one or more file folders 112A-F is received from the file watcher 116, the processing module 117 may implement the one or more tasks.

The one or more tasks implemented by the processing module 117 may include processing the files or data stored in the one or more file folders 112A-F (first task). In some examples, the files or data may be in a first format (when received by an external system and/or stored in the one or more file folders 112A-F), and processing the files or data may include converting the files or data from the first format to a second format. For example, the processing module 117 may transform data between various formats, such as from an ISO string to JSON, from JSON to XML or ISO string, and from XML to JSON.

The one or more tasks implemented by the processing module 117 may further include generating one or more reports based on the processed filed or data, and storing the one or more reports in the one or more file folders 112A-F (second task). In some examples, the one or more generated reports may be stored on a server (e.g., server 111A) or file folder (e.g., file folder 112A) that is the same as the server or file folder storing the data or files from which the one or more reports are generated. In other examples, the one or more generated reports may be stored on a server (e.g., server 111C) or folder (e.g., file folder 112B or 112E) that is different from the server or file folder storing the data or files from which the one or more reports are generated. In some examples, the one or more reports may include an analysis of the files or data.

The one or more tasks implemented by the processing module 117 may also include transmitting the one or more reports to one or more user accounts (e.g., user accounts 115C-D) associated with a server (e.g., server 111B) different from the server (e.g., 111A or 111C) that stores the files, data, and/or reports (third task). The one or more user accounts (e.g., user accounts 115C-D) received the one or more reports may have access to the second server (e.g., server 111B) and do not have access to the server (e.g., server 111A or 111C) that stores the files, data, or reports. Transmitting the one or more reports may include transferring the one or more reports from the server (111A or 111C) storing the one or more reports to the second server (111B) associated with the one or more user accounts.

The one or more tasks implemented by the processing module 117 may include notifying the one or more user accounts 115A-F about the transfer of the one or more reports (fourth task). For example, when the one or more reports are transferred from one server (e.g., server 111A or 111C) to another server (e.g., server 111B), the processing module 117 may notify the user accounts 115C-115D having access to the server (server 111B) to which the one or more reports are transferred.

In some examples, some or all of the tasks may be implemented in series. In this case, an implementation of one task may trigger an implementation of another task. For example, the implementation of the first task (e.g., processing the files or data) may trigger the implementation of the second task (e.g., generating and storing one or more reports), the implementation of the second task may trigger the implementation of the third task (e.g., transferring the one or more reports from one server to another server), and the implementation of the third task may trigger the implementation of the fourth task (e.g., notifying one or more user accounts about the transfer of the one or more reports). In this way, aspects of the present disclosure may enable automation of task workflows, thereby minimizing manual intervention, completing tasks without delays, and reducing overall task completion time.

In other examples, some or all of the tasks may be implemented in parallel. For example, once an event that triggers the start of a job occurs, some or all tasks of the job may be implemented in parallel. In some examples, the series and parallel implementations may be combined. For example, once an event that triggers the start of a job occurs, a first task may be implemented, which may trigger the implementation of a second task, which may trigger the parallel execution of third and fourth tasks.

In some examples, the processing module 117 may schedule and implement multiple workflows for various tasks. For example, the first to fourth tasks may be part of a first workflow, and the processing module 117 may schedule and implement a second workflow including a second-group of tasks. The second-group of tasks may include processing the files or data stored in the one or more file folders 112A-F (first second-group task), and transmitting the files or data stored in a first server (e.g., server 111A) to a second server (e.g., server 111B) (second second-group task). The second-group of tasks may further include notifying one or more user accounts about the transfer of the files or data (third second-group task). For example, once the files and data are transferred from the first server (e.g., server 111A) to the second server (e.g., server 111B), the processing module 117 may notify the user accounts 115C-115D having access to the second server (server 111B) to which the files or data are transferred.

In some examples, the implementation of the first second-group task (e.g., processing the files or data) may trigger the implementation of the second second-group task (e.g., transferring the files or data from the first server to the second server), and the implementation of the second second-group task may trigger the implementation of the third second-group task (e.g., notifying one or more user accounts about the transfer of the files or data).

In some examples, the processing module 117 may perform all or almost all of the functions of the task management system 110 that may not be performed by other modules or components of the task management system 110. In some examples, the processing module 117 may notify the one or more user accounts 115A-F about the status of at least one of the one or more tasks. For example, the processing module 117 may notify one or more user accounts 115C-D having access to the server (e.g., server 111B) to which the files, data, or reports are transferred about the status of at least one of the one or more tasks.

In some examples, the processing module 117 may schedule the one or more tasks to be implemented at a predetermined time. A workload of the task management system 110 at the predetermined time may be lower than an average daily workload of the task management system 110, and a network speed at the predetermined time may be faster than an average daily network speed. In some examples, the predetermined time may be between 12 AM and 6 AM, more particularly, between 1 AM and 5 AM, or between 2 AM and 4 AM (e.g., local time in the location of at least one of the servers 111A-C that stores the files, data, or reports or to which the files, data, or reports will be transferred). In this way, aspects of the present disclosure may be able to reduce system overload and enable faster and more efficient task completion.

In some examples, the processing module 117 may input files or data into the machine learning module 118. The machine learning module may analyze the files or data. In some examples, the machine learning module 118 may generate the one or more reports based on the analysis of the files or data. In some examples, the machine learning module may also determine an optimized time to implement the one or more jobs, workflows, or tasks by analyzing the filles, data, system workload history, and/or network speed history.

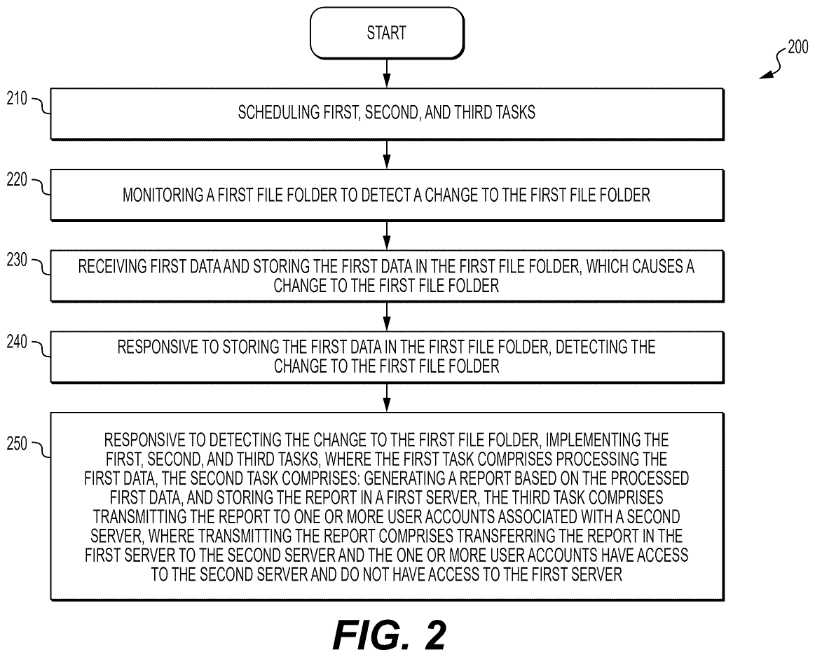

FIG. 2 is a flowchart showing a process for enhancing computer system workflow efficiency according to an aspect of the present disclosure. In various embodiments, the task management system 110 and/or one or more components thereof may perform one or more portions of the process 200 and may be implemented using, for instance, a chip set including a processor and a memory as shown in FIG. 4. As such, the task management system 110 and/or any of components thereof may provide means for accomplishing various parts of the process 200, as well as means for accomplishing embodiments of other processes described herein in conjunction with other components of the task management system 110. Although the process 200 is illustrated and described as a sequence of steps, it is contemplated that various embodiments of the process 200 are performed in any order or combination, need not include all of the illustrated steps, and may include additional or other steps.

In step 210, a system may schedule first, second, and third tasks. For example, the task management system 110 may schedule first, second, and third tasks of a first workflow.

In step 220, the system may monitor a first file folder to detect a change to the first file folder. For example, the task management system 110 (e.g., file watcher 116) may monitor a first file folder 112A to detect a change to the first file folder 112A.

In step 230, the system may receive first data and store the first data in the first file folder, which causes a change to the first file folder. For example, the task management system 110 may receive first data and store the first data in the first file folder 112A, which causes a change to the first file folder 112A.

In step 240, responsive to storing the first data in the first file folder, the system may detect the change to the first file folder. For example, responsive to storing the first data in the first file folder 112A, the task management system 110 (e.g., file watcher 116) may detect the change to the first file folder 112A.

In step 250, responsive to detecting the change to the first file folder, the system may implement the first, second, and third tasks. For example, responsive to detecting the change to the first file folder 112A, the task management system 110 (e.g., processing module 117) may implement the first, second, and third tasks. The first task may include processing the first data (e.g., converting the first data from a first format to a second format). The second task may include generating a report based on the processed first data and storing the report in a first server 111A. The third task may include transmitting the report to one or more user accounts 115C-D associated with a second server 111B. Transmitting the report may include transferring the report from the first server 111A to the second server 111B. In some examples, after the report is transmitted from the first server 111A to the second server 111B, the report may be deleted from the first server 111A to free up space in the first server 111A. The one or more user accounts 115C-D may have access to the second server 111B and may not have access to the first server 111A.

In some examples, the task management system 110 may schedule and implement a forth task, which may include notifying the one or more user accounts 115C-D about the transfer of the report. For example, once the report is transferred from the first server 111A to the second server 111B, the processing module 117 may notify the user accounts 115C-D having access to the second server 111B.

In some examples, the implementation of the first task may trigger the implementation of the second task, the implementation of the second task may trigger the implementation of the third task, and/or the implementation of the third task may trigger the implementation of the fourth task.

In some examples, at least one of the first to fourth tasks may be implemented at a first predetermined time. A workload of the task management system 110 at the first predetermined time may be lower than an average daily workload of the task management system 110, and a network speed at the first predetermined time may be faster than an average daily network speed. In some examples, the first predetermined time may be between 12 AM and 6 AM, more particularly, between 1 AM and 5 AM, or between 2 AM and 4 AM (e.g., local time in the location of the server 111A that stores the files, data, or reports or the server 111B to which the report will be transferred).

In some examples, the task management system 110 may schedule one or more tasks of a second workflow. For example, the task management system 110 may schedule first, second, and third second-group tasks. Then, the task management system 110 (e.g., file watcher 116) may monitor a second file folder 112B to detect a change to the second file folder 112B. The task management system 110 may receive second data and store the second data in the second file folder 112B, which causes a change to the second file folder 112B. in some examples, the second file folder 112B may be in the first server 111A.

Responsive to storing the second data in the second file folder 112B, the task management system 110 (e.g., file watcher 116) may detect the change to the second file folder 112B. Responsive to detecting the change to the second file folder, the task management system 110 may implement the first to third second-group tasks.

The first second-group task may include processing the second data (e.g., converting the second data from a first format to a second format). The second second-group task may include transferring the second data from the first server 111A to a third server 111C. In some examples, after the second data is transmitted from the first server 111A to the third server 111C, the second data may be deleted from the first server 111A to free up space in the first server 111A. The third second-group task may include notifying the one or more user accounts 115E-F about the transfer of the second data. For example, once the second is transferred from the first server 111A to the third server 111C, the processing module 117 may notify the user accounts 115E-F having access to the third server 111C. In some examples, the processing module 117 may notify the user accounts 115E-F via Email, SMS, or any other suitable channel. The user accounts 115E-F may not have access to the first server 111A and/or the second server 111B.

In some examples, the implementation of the first second-group task may trigger the implementation of the second second-group task, and/or the implementation of the second second-group task may trigger the implementation of the third second-group task.

In some examples, at least one of the first to third second-group tasks may be implemented at a second predetermined time. A workload of the task management system 110 at the second predetermined time may be lower than an average daily workload of the task management system 110, and a network speed at the second predetermined time may be faster than an average daily network speed. In some examples, the first predetermined time may be between 12 AM and 6 AM, more particularly, between 1 AM and 5 AM, or between 2 AM and 4 AM (e.g., local time in the location of the server 111A that stores the second data or the server 111C to which the second data will be transferred).

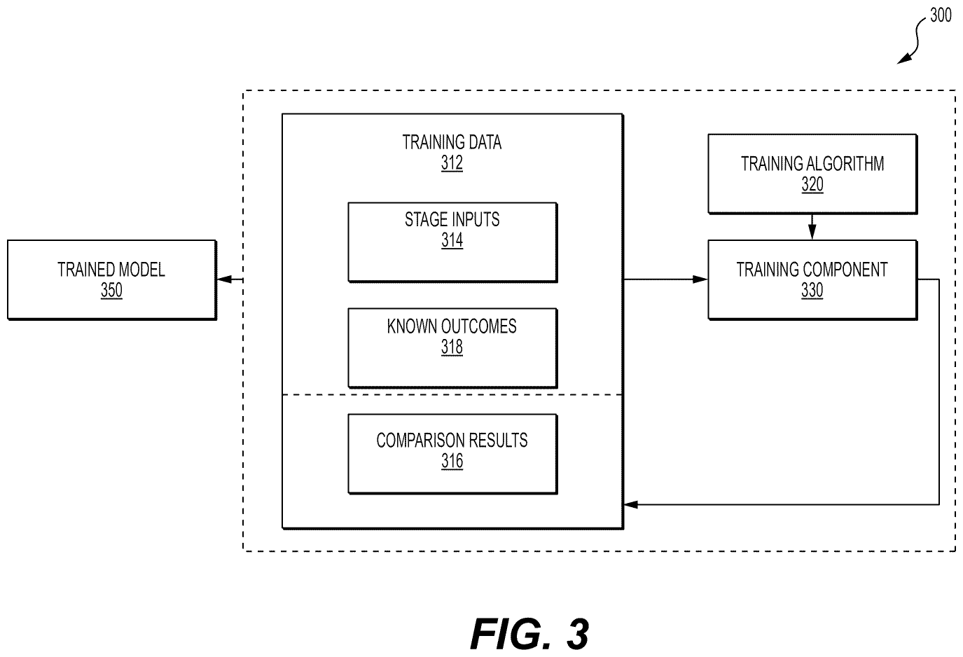

FIG. 3 depicts a flow diagram for training a machine learning model, in accordance with an aspect of the disclosed subject matter. As shown in flow diagram 300 of FIG. 3, training data 312 may include one or more of stage inputs 314 and known outcomes 318 related to a machine learning model to be trained. The stage inputs 314 may be from any applicable source including a component or set shown in the figures provided herein. The known outcomes 318 may be included for machine learning models generated based on supervised or semi-supervised training. An unsupervised machine learning model might not be trained using known outcomes 318. Known outcomes 318 may include known or desired outputs for future inputs similar to or in the same category as stage inputs 314 that do not have corresponding known outputs.

The training data 312 and a training algorithm 320 may be provided to a training component 330 that may apply the training data 312 to the training algorithm 320 to generate a trained machine learning model 350. According to an implementation, the training component 330 may be provided comparison results 316 that compare a previous output of the corresponding machine learning model to apply the previous result to re-train the machine learning model. The comparison results 316 may be used by the training component 330 to update the corresponding machine learning model. The training algorithm 320 may utilize machine learning networks and/or models including, but not limited to a deep learning network such as Deep Neural Networks (DNN), Convolutional Neural Networks (CNN), Fully Convolutional Networks (FCN) and Recurrent Neural Networks (RCN), probabilistic models such as Bayesian Networks and Graphical Models, and/or discriminative models such as Decision Forests and maximum margin methods, or the like. The output of the flow diagram 300 may be a trained machine learning model 350. In some examples, the trained machine learning model 350 may be the machine learning module 118 or at least part of the machine learning module 118.

A machine learning model disclosed herein may be trained by adjusting one or more weights, layers, and/or biases during a training phase. During the training phase, historical or simulated data may be provided as inputs to the model. The model may adjust one or more of its weights, layers, and/or biases based on such historical or simulated information. The adjusted weights, layers, and/or biases may be configured in a production version of the machine learning model (e.g., a trained model) based on the training. Once trained, the machine learning model may output machine learning model outputs in accordance with the subject matter disclosed herein. According to an implementation, one or more machine learning models disclosed herein may continuously update based on feedback associated with use or implementation of the machine learning model outputs.

As illustrated in FIG. 4, the computer system 400 may include a processor 402, e.g., a central processing unit (CPU), a graphics processing unit (GPU), or both. The processor 402 may be a component in a variety of systems. For example, the processor 402 may be part of a standard personal computer or a workstation. The processor 402 may be one or more general processors, digital signal processors, application specific integrated circuits, field programmable gate arrays, servers, networks, digital circuits, analog circuits, combinations thereof, or other now known or later developed devices for analyzing and processing data. The processor 402 may implement a software program, such as code generated manually (i.e., programmed).

The computer system 400 may include a memory 404 that can communicate via a bus 408. The memory 404 may be a main memory, a static memory, or a dynamic memory. The memory 404 may include, but is not limited to computer readable storage media such as various types of volatile and non-volatile storage media, including but not limited to random access memory, read-only memory, programmable read-only memory, electrically programmable read-only memory, electrically erasable read-only memory, flash memory, magnetic tape or disk, optical media and the like. In one implementation, the memory 404 includes a cache or random-access memory for the processor 402. In alternative implementations, the memory 404 is separate from the processor 402, such as a cache memory of a processor, the system memory, or other memory. The memory 404 may be an external storage device or database for storing data. Examples include a hard drive, compact disc (“CD”), digital video disc (“DVD”), memory card, memory stick, floppy disc, universal serial bus (“USB”) memory device, or any other device operative to store data. The memory 404 is operable to store instructions executable by the processor 402. The functions, acts or tasks illustrated in the figures or described herein may be performed by the programmed processor 402 executing the instructions stored in the memory 404. The functions, acts or tasks are independent of the particular type of instructions set, storage media, processor or processing strategy and may be performed by software, hardware, integrated circuits, firm-ware, micro-code and the like, operating alone or in combination. Likewise, processing strategies may include multiprocessing, multitasking, parallel payment and the like.

As shown, the computer system 400 may further include a display unit 410, such as a liquid crystal display (LCD), an organic light emitting diode (OLED), a flat panel display, a solid-state display, a cathode ray tube (CRT), a projector, a printer or other now known or later developed display device for outputting determined information. The display unit 410 may act as an interface for the user to see the functioning of the processor 402, or specifically as an interface with the software stored in the memory 404 or in a drive unit 406.

Additionally or alternatively, the computer system 400 may include an input/output device 412 configured to allow a user to interact with any of the components of system 400. The input/output device 412 may be a number pad, a keyboard, or a cursor control device, such as a mouse, or a joystick, touch screen display, remote control, or any other device operative to interact with the computer system 400.

The computer system 400 may also or alternatively include a disk or optical unit as the drive unit 406. The drive unit 406 may include a computer-readable medium 422 in which one or more sets of instructions 424, e.g., software, can be embedded. Further, the instructions 424 may embody one or more of the methods or logic as described herein. The instructions 424 may reside completely or partially within the memory 404 and/or within the processor 402 during execution by the computer system 400. The memory 404 and the processor 402 also may include computer-readable media as discussed above.

In some systems, a computer-readable medium 422 includes instructions 424 or receives and executes instructions 424 responsive to a propagated signal so that a device connected to a network 430 can communicate voice, video, audio, images, or any other data over the network 430. Further, the instructions 424 may be transmitted or received over the network 430 via a communication port or interface 420, and/or using a bus 408. The communication port or interface 420 may be a part of the processor 402 or may be a separate component. The communication port 420 may be created in software or may be a physical connection in hardware. The communication port 420 may be configured to connect with a network 430, external media, the display unit 410, or any other components in system 400, or combinations thereof. The connection with the network 430 may be a physical connection, such as a wired Ethernet connection or may be established wirelessly as discussed below. Likewise, the additional connections with other components of the system 400 may be physical connections or may be established wirelessly. The network 430 may alternatively be directly connected to the bus 408.

While the computer-readable medium 422 is shown to be a single medium, the term “computer-readable medium” may include a single medium or multiple media, such as a centralized or distributed database, and/or associated caches and servers that store one or more sets of instructions. The term “computer-readable medium” may also include any medium that is capable of storing, encoding, or carrying a set of instructions for execution by a processor or that cause a computer system to perform any one or more of the methods or operations disclosed herein. The computer-readable medium 422 may be non-transitory, and may be tangible.

The computer-readable medium 422 can include a solid-state memory such as a memory card or other package that houses one or more non-volatile read-only memories. The computer-readable medium 422 can be a random-access memory or other volatile re-writable memory. Additionally or alternatively, the computer-readable medium 422 can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored.

In an alternative implementation, dedicated hardware implementations, such as application specific integrated circuits, programmable logic arrays and other hardware devices, can be constructed to implement one or more of the methods described herein. Applications that may include the apparatus and systems of various implementations can broadly include a variety of electronic and computer systems. One or more implementations described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

The computer system 400 may be connected to one or more networks 430. The network 430 may define one or more networks including wired or wireless networks. The wireless network may be a cellular telephone network, an 802.11, 802.16, 802.20, or WiMAX network. Further, such networks may include a public network, such as the Internet, a private network, such as an intranet, or combinations thereof, and may utilize a variety of networking protocols now available or later developed including, but not limited to TCP/IP based networking protocols. The network 430 may include wide area networks (WAN), such as the Internet, local area networks (LAN), campus area networks, metropolitan area networks, a direct connection such as through a Universal Serial Bus (USB) port, or any other networks that may allow for data communication. The network 430 may be configured to couple one computing device to another computing device to enable communication of data between the devices. The network 430 may generally be enabled to employ any form of machine-readable media for communicating information from one device to another. The network 430 may include communication methods by which information may travel between computing devices. The network 430 may be divided into sub-networks. The sub-networks may allow access to all of the other components connected thereto or the sub-networks may restrict access between the components. The network 430 may be regarded as a public or private network connection and may include, for example, a virtual private network or an encryption or other security mechanism employed over the public Internet, or the like. The network 430 may be the network 105, or another network.

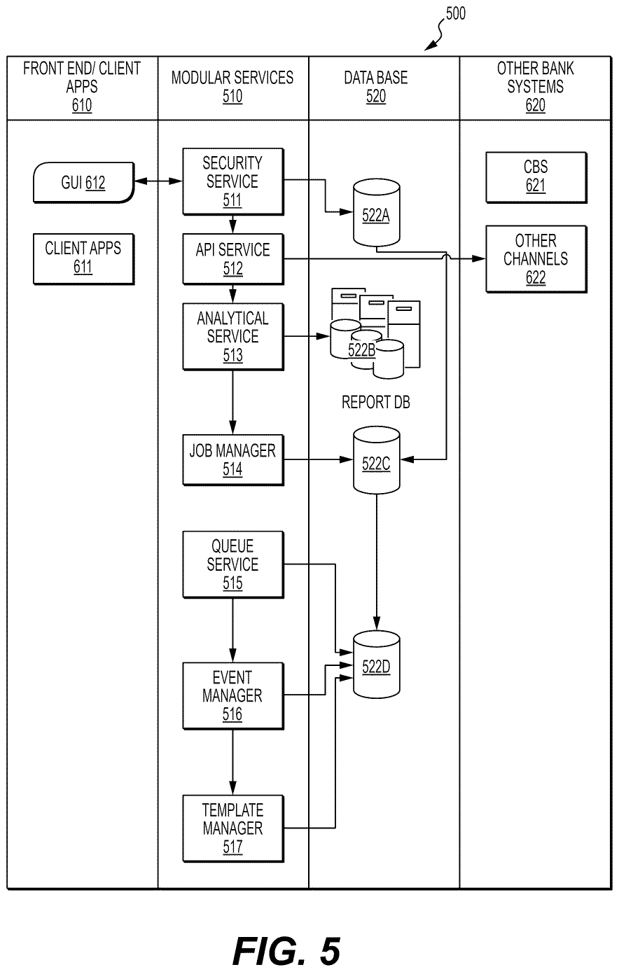

FIG. 5 illustrates an exemplary system 500 for enhancing computer system workflow efficiency according to an example of the present disclosure. As shown in FIG. 5, the system 500 may include a modular services section 510 and a database section 520. In some examples, the system 500 may receive a request or message from one or more client applications 611 in a front end/client applications section 610 of FIG. 5, for example, via a graphical user interface 612. In some examples, the system may also include a module that connects the system 500 with the other bank systems 620, such as a Core Bank System (CBS) 621 and other channels 622.

The modular services section 510 may include a security service 511, an API service 512, an analytical service 513, a job manager 514, a queue service 515, an event manager 516, and a template manager 517. The database section 520 may include a plurality of databases 522A-D storing files or data from one or more components of the modular services section 510.

The security service 511 may be configured to authenticate an external user (e.g., client 101) and/or the request/message. The security service 511 may issue tokens (e.g., digital key) used for authentication of the external user, request, or message. The security service 511 may store files or data in a first database 522A.

The API service 512 may serve as a load balancer or gateway configured to transfer a request from API to internal services (e.g., receiving the requests or messages from the client applications (after passing the security service 511) and transmitting them to one or more components in the system 500). The API service 512 may also communicate with other channels 622.

The analytical service 513 may analyze data related to the requests or messages, and generate one or more reports (for example, by running SQL). In some examples, the one or more reports may include information tracking the list of configured jobs and activities performed by the system 500. The analytical service 513 may generate various types of reports based on configuration files. The analytical service 513 may store the one or more reports in a second database 522B (e.g., report database).

The job manager 514 may schedule one or more jobs/workflows having one or more tasks, such as a report generation, file transfer, and/or file monitoring. In some examples, a job can be configured to trigger any existing one or more APIs in a series or a parallel way.

In some examples, the job manager 514 may schedule a job to transmit data to the machine learning module 118 for AI processing. The data may be transmitted to the machine learning module 118 periodically, randomly, or on demand. In some examples, the job manager 514 may schedule a job to transmit the transformed data to JMS queue, Kafka, or any other suitable queues. In some examples, the job manager 514 may schedule a job to trigger serverless applications (e.g., Azure serverless application, AWS serverless application). In some examples, the job/workflow in the system 500 may be initiated via a cron job, an API call, a file listener, or a manual trigger.

The job manager 514 may schedule the one or more jobs/workflows to be performed at a predetermined time. Then, the system 500 may run any binaries necessary to perform the scheduled task at the predetermined time. In some examples, each job/workflow may include a sequence of binaries (e.g., compiled from java, C, C++, python) that can be run in a specific order, for example, based on previous job completion. The job manager 514 may use a third database 522C for storing any data or files handled by the job manager 514.

The queue service 515 may temporarily hold the jobs or tasks, for example, in a predetermined order until the jobs or tasks can be processed by other components of the system 500. The event manager 516 may detect or handle events occurring within the system. The template manager 517 may generate a notification template (e.g., email template, SMS template, any suitable template) that can be used when sending a notification to one or more user accounts. The queue service 515, event manager 516, and template manager 517 may use a fourth database 522D for storing any data or files handled by these modules.

In some examples, the system 500 may be backed up by Apache Camel, which supports a wide range of handlers, such as HTTP, UDP, TCP, SFTP, and FILE. These handlers can be configured and run either synchronously or asynchronously through the configuration file. In addition, the system 500 may offer various features including workflow configuration (e.g., a page to design the process for each job) and/or audit log (e.g., recording the stages of activities within the application).

In some examples, the system 500 may be a monolithic application that operates independently without relying on any external services within the system. The system 500 may be able to run on any system that supports Java 8. The maintenance cost for the system 500 may be significantly lower compared to other systems due to its standalone nature. In some examples, the system 500 may be built on a tech stack including various building blocks, which may include Java 8, React 17, and/or Spring Boot v1.5. The system 500 may also use database management systems, such as Oracle 19G, Postgres, MySQL for enhanced product support and data management.

In some examples, the system 500 may allow any Unix or Linux commands to be executed in the system 500. Also, any file or data in the system 500 can be encrypted, for example, using the PGP/GPG format. In some examples, the system 500 may transfer files or data from a local folder to SFTP, or from the SFTP to a local folder. In some examples, the system 500 can run commands, binaries, or executable files (EXEs) on Unix-based machines and/or Windows machines, schedule their execution, extract the output, and distribute it through one or more methods, for example, by transferring a file via SFTP, sending an email, or transmitting the message through an API. In some examples, the system 500 may also pass through any format of message from one channel to another channel. In some examples, source and/or destination messages can be in any format, which can be stored in a database (e.g., 522A-D) for audit purposes.

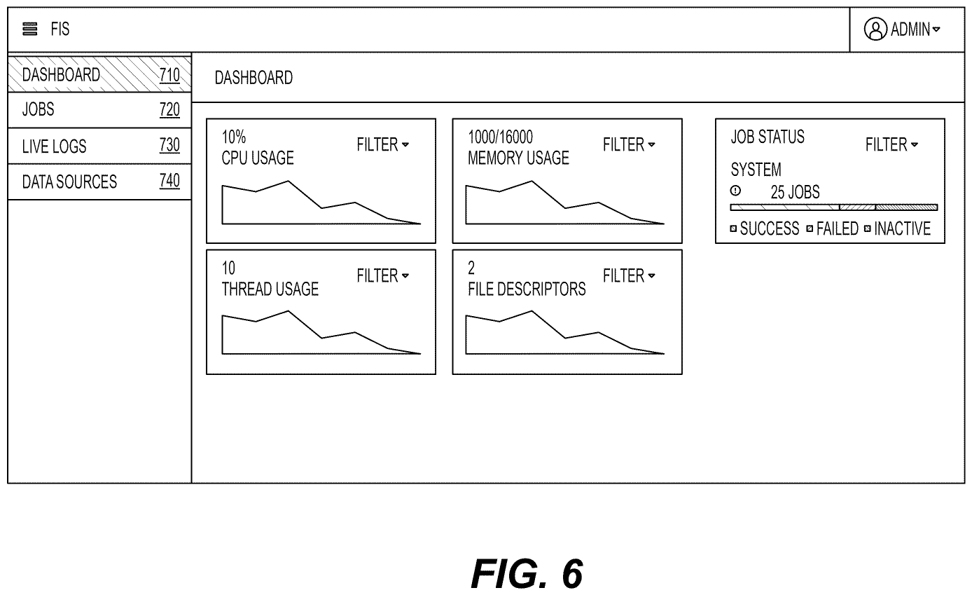

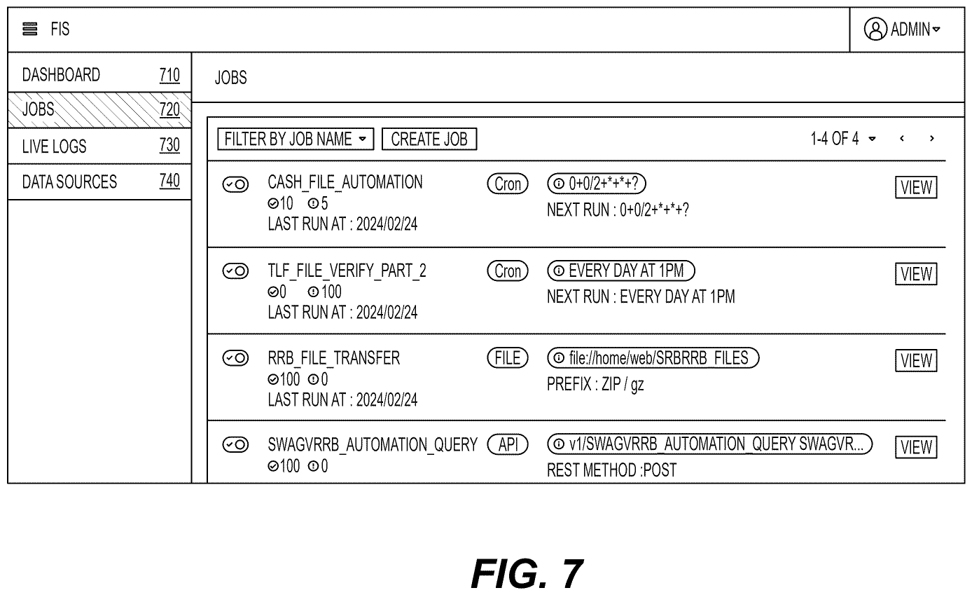

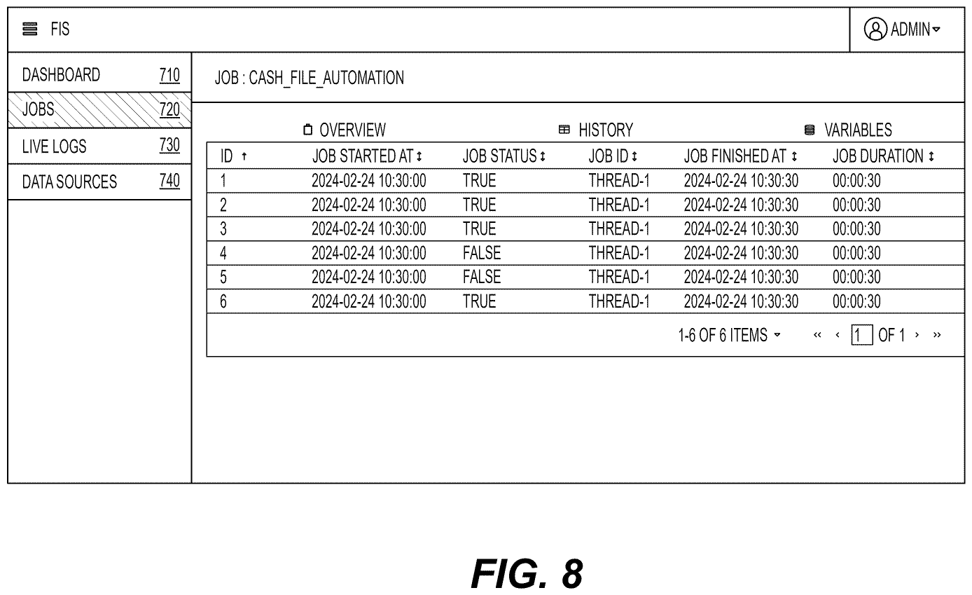

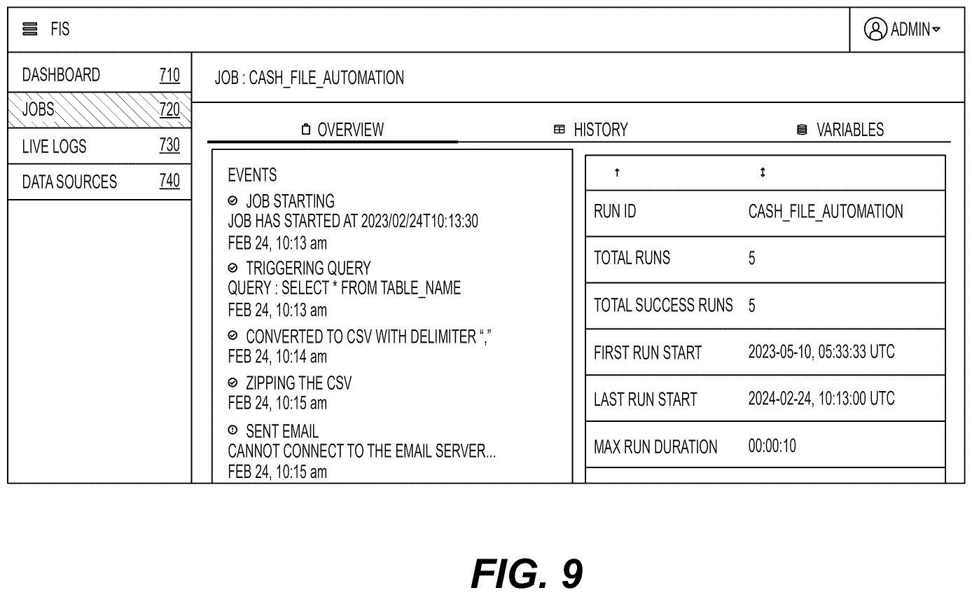

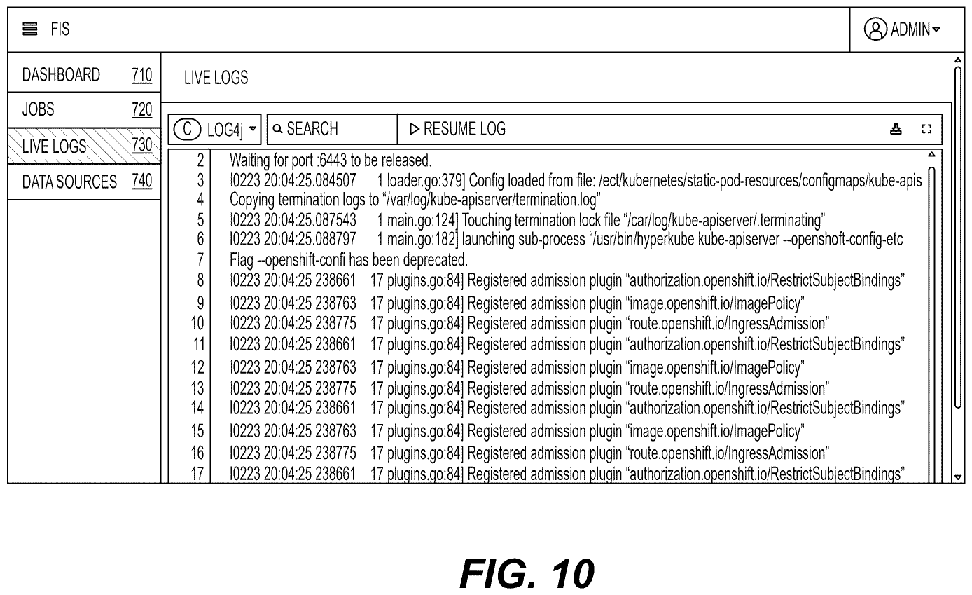

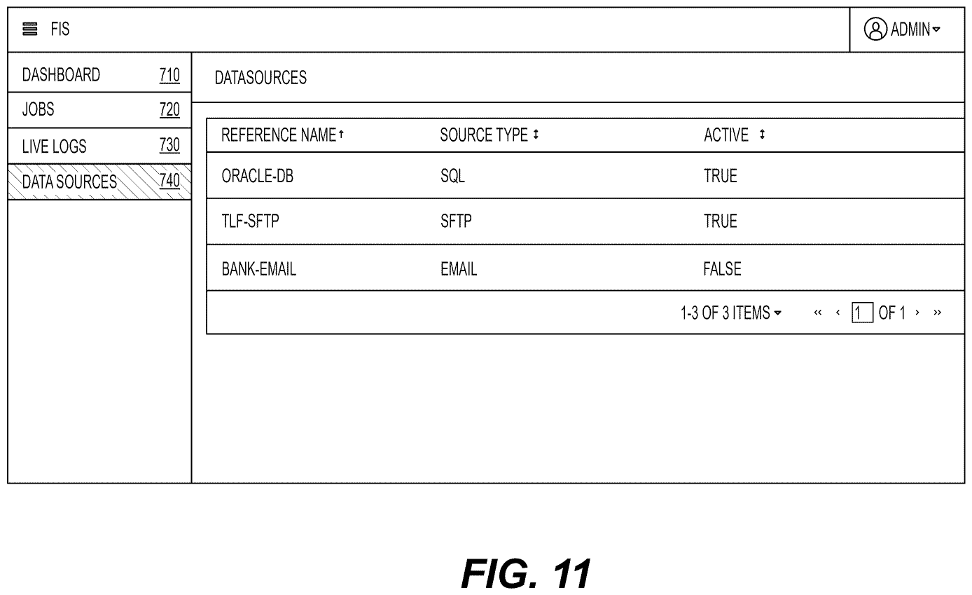

FIGS. 6-11 illustrate user interfaces of a system according to an example of the present disclosure. For example, FIG. 6 illustrates a dashboard section 710 showing the status of the system, including CPU usage, memory usage, thread usage, file descriptors, and job status. FIG. 7 illustrates a jobs section 720 showing various jobs/workflows generated in the system. In some examples, the jobs/workflows can be activated or deactivated by toggling a button. FIG. 8 illustrates the status of one of the jobs/workflows shown in FIG. 7. FIG. 9 illustrates a detailed workflow of one of the jobs/workflows shown in FIG. 7. FIG. 10 illustrates a live logs section 730 displaying real-time log data generated as events take place within the system. FIG. 11 illustrates a data sources section 740 showing various data sources available to the system.

In accordance with various implementations of the present disclosure, the methods described herein may be implemented by software programs executable by a computer system. Further, in an exemplary, non-limited implementation, implementations can include distributed processing, component/object distributed processing, and parallel payment. Alternatively, virtual computer system processing can be constructed to implement one or more of the methods or functionality as described herein.

Although the present specification describes components and functions that may be implemented in particular implementations with reference to particular standards and protocols, the disclosure is not limited to such standards and protocols. For example, standards for Internet and other packet switched network transmission (e.g., TCP/IP, UDP/IP, HTML, HTTP, etc.) represent examples of the state of the art. Such standards are periodically superseded by faster or more efficient equivalents having essentially the same functions. Accordingly, replacement standards and protocols having the same or similar functions as those disclosed herein are considered equivalents thereof.

It will be understood that the steps of methods discussed are performed in one embodiment by an appropriate processor (or processors) of a processing (i.e., computer) system executing instructions (computer-readable code) stored in storage. It will also be understood that the disclosed embodiments are not limited to any particular implementation or programming technique and that the disclosed embodiments may be implemented using any appropriate techniques for implementing the functionality described herein. The disclosed embodiments are not limited to any particular programming language or operating system.

It should be appreciated that in the above description of exemplary embodiments, various features of the embodiments are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that a claimed embodiment requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment.

Furthermore, while some embodiments described herein include some but not other features included in other embodiments, combinations of features of different embodiments are meant to be within the scope of the present disclosure, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the function.

In the description provided herein, numerous specific details are set forth. However, it is understood that embodiments of the present disclosure may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the present disclosure, those skilled in the art will recognize that other and further modifications may be made thereto without departing from the spirit of the present disclosure, and it is intended to claim all such changes and modifications as falling within the scope of the present disclosure. For example, any formulas given above are merely representative of procedures that may be used. Functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

What is claimed is:

1. A computer-implemented method comprising:
scheduling, by one or more processors in a system, first, second, and third tasks;
monitoring, by the one or more processors, a first file folder to detect a change to the first file folder;
receiving, by the one or more processors, first data and storing, by the one or more processors, the first data in the first file folder, which causes a change to the first file folder;
responsive to storing the first data in the first file folder, detecting, by the one or more processors, the change to the first file folder;
responsive to detecting the change to the first file folder, implementing, by the one or more processors, the first, second, and third tasks,
wherein the first task comprises processing the first data,
wherein the second task comprises:
generating a report based on the processed first data; and
storing the report in a first server,
wherein the third task comprises transmitting the report to one or more user accounts associated with a second server, wherein transmitting the report comprises transferring the report in the first server to the second server, wherein the one or more user accounts have access to the second server and do not have access to the first server,
wherein the implementation of the first task triggers the implementation of the second task,
wherein the implementation of the second task triggers the implementation of the third task.

2. The computer-implemented method of claim 1, wherein the first data is in a first format, and wherein processing the first data comprises converting the first data from the first format to a second format.

3. The computer-implemented method of claim 1, wherein at least one of the first task, the second task, or the third task is scheduled to be implemented at a first predetermined time.

4. The computer-implemented method of claim 3, wherein a workload of the system at the first predetermined time is lower than an average daily workload of the system, ensuring a network speed at the first predetermined time faster than an average daily network speed.

5. The computer-implemented method of claim 3, wherein the first predetermined time is between 12 AM and 6 AM.

6. The computer-implemented method of claim 1, further comprising:
scheduling, by the one or more processors in a system, a fourth task; and
implementing, by the one or more processors, the fourth task,
wherein the fourth task comprises notifying the one or more user accounts about the transfer of the report,
wherein the implementation of the third task triggers the implementation of the fourth task.

7. The computer-implemented method of claim 1, further comprising notifying the one or more user accounts about a status of at least one of the first task, the second task, or the third task.

8. The computer-implemented method of claim 1, further comprising:
scheduling, by the one or more processors, a fifth task;
monitoring, by the one or more processors, a second file folder to detect a change to the second file folder;
receiving, by the one or more processors, second data and storing, by the one or more processors, the second data in the second file folder, which causes a change to the second file folder, wherein the second file folder is in the first server;
responsive to storing the second data in the second file folder, detecting, by the one or more processors, the change to the second file folder; and
responsive to detecting the change to the second file folder, implementing, by the one or more processors, the fifth task,
wherein the fifth task comprises transferring the second data from the first server to the second server.

9. The computer-implemented method of claim 8, wherein the second data comprises at least one of transaction logs, access logs, customer data files, or backup files.

10. The computer-implemented method of claim 8, wherein the fifth task is scheduled to be implemented at a second predetermined time, wherein a workload of the system at the second predetermined time is lower than an average daily workload of the system, ensuring a network speed at the second predetermined time faster than an average daily network speed.

11. The computer-implemented method of claim 8, wherein the second data is transferred to the second server after the second data is processed by the one or more processors.

12. A system comprising:
one or more processors of a computing system; and
at least one non-transitory computer readable medium storing instructions which, when executed by the one or more processors, cause the one or more processors to perform operations comprising:
scheduling first, second, and third tasks;
monitoring a first file folder to detect a change to the first file folder;
receiving first data and storing the first data in the first file folder, which causes a change to the first file folder;
responsive to storing the first data in the first file folder, detecting the change to the first file folder;
responsive to detecting the change to the first file folder, implementing the first, second, and third tasks,
wherein the first task comprises processing the first data,
wherein the second task comprises:
generating a report based on the processed first data; and
storing the report in a first server,
wherein the third task comprises transmitting the report to one or more user accounts associated with a second server, wherein transmitting the report comprises transferring the report in the first server to the second server, wherein the one or more user accounts have access to the second server and do not have access to the first server,
wherein the implementation of the first task triggers the implementation of the second task,
wherein the implementation of the second task triggers the implementation of the third task.

13. The system of claim 12, wherein the first data is in a first format, and wherein processing the first data comprises converting the first data from the first format to a second format.

14. The system of claim 12, wherein at least one of the first task, the second task, or the third task is scheduled to be implemented at a first predetermined time.

15. The system of claim 14, wherein a workload of the system at the first predetermined time is lower than an average daily workload of the system, ensuring a network speed at the first predetermined time faster than an average daily network speed.

16. The system of claim 12, wherein the operations further comprise:
scheduling, by the one or more processors in a system, a fourth task; and
implementing the fourth task,
wherein the fourth task comprises notifying the one or more user accounts about the transfer of the report,
wherein the implementation of the third task triggers the implementation of the fourth task.

17. The system of claim 12, further comprising:
scheduling a fifth task;
monitoring a second file folder to detect a change to the second file folder;
receiving second data and storing the second data in the second file folder, which causes a change to the second file folder, wherein the second file folder is in the first server;
responsive to storing the second data in the second file folder, detecting the change to the second file folder; and
responsive to detecting the change to the second file folder, implementing the fifth task,
wherein the fifth task comprises transferring the second data from the first server to the second server.

18. The system of claim 17, wherein the second data comprises at least one of transaction logs, access logs, customer data files, or backup files.

19. The system of claim 17, wherein the second data is transferred to the second server after the second data is processed by the one or more processors.

20. A non-transitory computer readable medium, the non-transitory computer readable medium storing instructions which, when executed by one or more processors of a computing system, cause the one or more processors to perform operations comprising:
scheduling first, second, and third tasks;
monitoring a first file folder to detect a change to the first file folder;
receiving first data and storing the first data in the first file folder, which causes a change to the first file folder;
responsive to storing the first data in the first file folder, detecting the change to the first file folder; and
responsive to detecting the change to the first file folder, implementing the first, second, and third tasks,
wherein the first task comprises processing the first data,
wherein the second task comprises:
generating a report based on the processed first data; and
storing the report in a first server,
wherein the third task comprises transmitting the report to one or more user accounts associated with a second server, wherein transmitting the report comprises transferring the report in the first server to the second server, wherein the one or more user accounts have access to the second server and do not have access to the first server,
wherein the implementation of the first task triggers the implementation of the second task,
wherein the implementation of the second task triggers the implementation of the third task.
